(19) United States
(12) Patent Application Publication
(10) Pub. No.: US 2015/0048529 A1
(43) Pub. Date: Feb. 19, 2015

(54) Pressurized Air Dissolved In Fuel/Fuel Tanks For Cleaner Burning of Fuel

(71) Applicant: Matthew S. Jones, Colorado Springs, CO (US)

(72) Inventor: Matthew S. Jones, Colorado Springs, CO (US)

(21) Appl. No.: 13/969,567

(22) Filed: Aug. 18, 2013

(51) Int. Cl. F02M 25/00; F02M 31/20

(52) U.S. Cl. CPC F02M 25/00; F02M 31/20
USPC 261/128; 366/348

(57) ABSTRACT

The Process of Dissolving Air through Pressure/cooling, Into a Fuel Containment (Fuel Tank) Device.

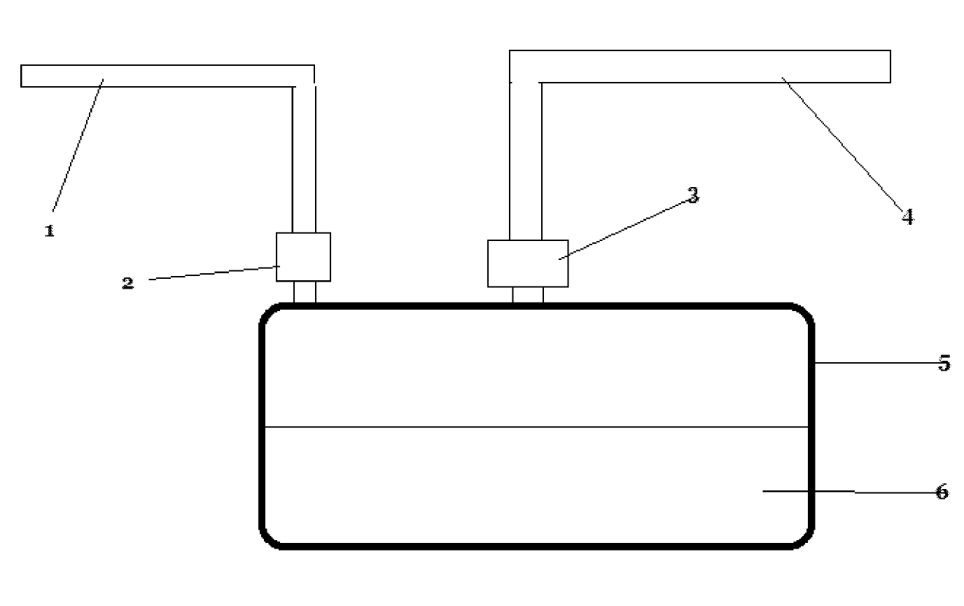

### BACKGROUND

Using Pressurized Air through some Compressor, Connected or not Connected to the Engine or Fuel Burning Device, Promotes Cleaner and Fuller Burning of Fuels, Dissolved Air is Fundamentally Used to Separate Fuel Molecules allowing for Better Atomization during Injection in a Engine, as well as Better Fuel Delivery/timing, Mixing and faster Burning of Fuel with Close Proximity to Oxygen,

Air is Pressurized into a Air tight Fuel Tank where the Air or Oxygen Dissolves into the Fuel, Refrigeration or cooling of Fuel may be used in Conjunction to increase the Amount of Oxygen able to Dissolve into the Fuel.

1 and 2 tube and Discharge Valve for use by Operator before opening and refueling container,

3 and 4 Air fitting Connected to the uppermost part of the fuel Container, and tube running to a air Compressor for Use during Operation of the Engine.

5, fuel Tank/Container,

6, Fuel.

1. The Invention is the Process of Dissolving Air through Pressure/cooling, Into a Fuel Containment (Fuel Tank) Device.
